(19) United States
(12) Patent Application Publication
(10) Pub. No.: US 2012/0297350 A1
(43) Pub. Date: Nov. 22, 2012

(54) CHIP SIZE ESTIMATING APPARATUS FOR SEMICONDUCTOR INTEGRATED CIRCUIT AND CHIP SIZE ESTIMATING METHOD FOR SEMICONDUCTOR INTEGRATED CIRCUIT

(75) Inventor: Yuji Yamamoto, Kanagawa (JP)

(73) Assignee: KABUSHIKI KAISHA TOSHIBA, Tokyo (JP)

(21) Appl. No.: 13/365,063

(22) Filed: Feb. 2, 2012

(30) Foreign Application Priority Data
May 20, 2011 (JP) 2011-113926

(51) Int. Cl. G06F 17/50

(52) U.S. Cl. 716/102

(57) ABSTRACT

A chip size estimating apparatus for a semiconductor integrated circuit of an embodiment has an input section configured to input a minimum number of functional gates that is a minimum number of gates necessary for realization of a function of a circuit, a set value holding section in which a performance-considered number-of-gates coefficient that is a ratio of a number of gates to be necessary for achievement of a predetermined operation speed to the minimum number of functional gates is set in advance for each cell library, and a calculating section configured to estimate a total area of the circuit by using a number of gates that is calculated from the minimum number of functional gates and the performance-considered number-of-gates coefficient.

### CROSS REFERENCE TO RELATED APPLICATION

This application is based upon and claims the benefit of priority from the Japanese Patent Application No. 2011-113926, filed on May 20, 2011; the entire contents of which are incorporated herein by reference.

### FIELD

An embodiment described herein relates generally to a chip size estimating apparatus for a semiconductor integrated circuit, and a chip size estimating method for a semiconductor integrated circuit.

### BACKGROUND

Conventionally, when a chip size of a semiconductor integrated circuit is estimated, a circuit size is generally expressed in a number of gates and is set as input information for estimation, with respect to a random logic part which is configured by standard cells. In general, estimation is performed with respect to a plurality of different cell libraries of, for example, seven grids, nine grids and the like, and actual circuit design and production of a semiconductor integrated circuit are often performed with use of the cell library in a smaller size.

When estimation of chip sizes is performed for a plurality of different cell libraries and the results are compared, if the same number of gates is used as the input information for estimation of all the cell libraries, the total area of the cell library of the grids with a smaller cell height tends to be smaller, irrespective of the operating frequency of the cell. (That is to say, the total area of the cells of the cell library of seven grids is always estimated to be smaller than the cell library of nine grids irrespective of the operating frequency.)

However, in actual circuit design, as the operating frequency becomes higher, the cells with larger drive capacities are used, and buffers are interposed. At this time, cell libraries of grids with higher cell heights have better performance of the cells even with the same number of gates, and are higher in operation speed in many cases. Accordingly, when the operating frequency becomes high, use of the cell library of the grids with a higher cell height more suppresses use of the cells with larger drive capacities and interposition of buffers. That is, in the cell library of the grids with a higher cell height, the circuit size tends to be smaller, and the number of gates tends to be smaller. Therefore, in reality, as the operating frequency becomes higher, the cell library of the grids with a higher cell height is likely to have a smaller total area of cells.

As above, when the chip sizes of a plurality of different cell libraries are estimated and the results are compared, the same number of gates is conventionally inputted as the circuit size. Therefore, there is a problem that as the operating frequency becomes higher, the estimation accuracy reduces, a correct comparison result cannot be derived, and a cell library that is not optimal is selected.

A method is conceivable, which sets the number of gates that is used as input for estimation to the value corresponding to an individual cell library to be an object, but the method has problems that performing logic synthesis or the like of circuits for each estimation for each cell library requires much efforts and cost, and logic synthesis itself cannot be performed if there is less information.

### BRIEF DESCRIPTION OF THE DRAWINGS

FIG. 1 is a diagram explaining one example of a configuration of a chip size estimating apparatus for a semiconductor integrated circuit according to an embodiment;

FIG. 2 is a diagram explaining one example of a chip size estimating coefficient table 23;

FIG. 3 is a diagram explaining one example of a circuit that is designed in consideration of operation timing;

FIG. 4 is a diagram explaining a circuit that is configured with an objective of only realizing a function similar to that of the circuit of FIG. 3 without consideration of the operation timing;

FIG. 5 is a diagram explaining one example of layout of a chip that is an object of estimation of a chip size;

FIG. 6 is a flowchart explaining a procedure of estimating an area of a random logic section 7;

FIG. 7 is a graph showing a relation of a total cell area calculated according to the embodiment with respect to the random logic section 7 of FIG. 6 and an operating frequency;

FIGS. 8A and 8B are diagrams explaining layout of cells of objects of estimation;

FIG. 9 is a graph showing a relation of the total cell area calculated according to a conventional method and the operating frequency;

FIG. 10 is a diagram explaining one example of a chip size estimating coefficient table 23′;

FIG. 11 is a diagram explaining one example of a circuit that is designed in consideration of operation timing with use of a cell library configured only by basic cells;

FIG. 12 is a diagram explaining a circuit that is configured with an objective of only realizing a function similar to that of the circuit of FIG. 11 without consideration of the operation timing; and

FIG. 13 is a diagram explaining one example of a circuit that has a function similar to that of the circuit of FIG. 11, and is designed in consideration of the operation timing with use of a different cell library including a composite cell.

### DETAILED DESCRIPTION

A chip size estimating apparatus for a semiconductor integrated circuit of an embodiment has an input section configured to input a minimum number of functional gates that is a minimum number of gates necessary for realization of a function of a circuit, a set value holding section in which a performance-considered number-of-gates coefficient that is a ratio of a number of gates to be necessary for achievement of a predetermined operation speed to the minimum number of functional gates is set in advance for each cell library, and a calculating section configured to estimate a total area of the circuit by using a number of gates that is calculated from the minimum number of functional gates and the performance-considered number-of-gates coefficient.

An embodiment of the invention will be described with reference to the drawings.

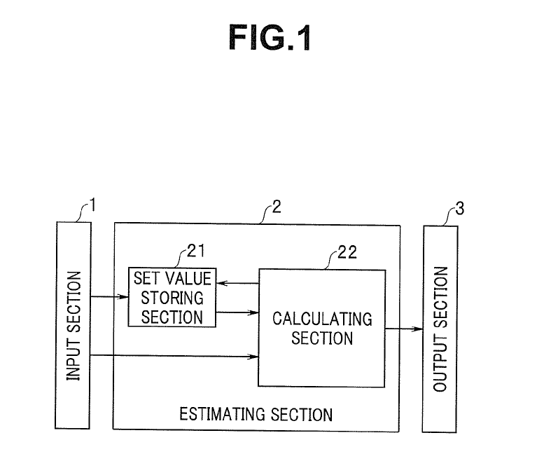

First, a configuration of a chip size estimating apparatus for a semiconductor integrated circuit of the present embodiment will be described with reference to FIG. 1. FIG. 1 is a diagram explaining one example of the configuration of the chip size estimating apparatus for a semiconductor integrated circuit according to the present embodiment.

As shown in FIG. 1, the chip size estimating apparatus for a semiconductor integrated circuit includes an input section 1 configured to input an estimation condition and the like, an estimating section 2 configured to perform estimation of a chip size from inputted information or the like, and an output section 3 configured to output an estimation result.

The input section 1 is a section configured to input the number of gates that expresses a circuit size of a random logic section mounted on a chip, an operating frequency, a cell library of an object to be estimated and the like, and includes, for example, a keyboard, a touch panel or the like.

The estimating section 2 is configured by a set value storing section 21 configured to store various set values for use in estimation, and a calculating section 22 configured to calculate a total area of a random logic section with use of data inputted from the input section 1 and the set value stored in the set value storing section 21, and perform estimation of a chip size.

The output section 3 is a section configured to output a result of estimation that is performed in the estimating section 2, and includes, for example, a display or the like.

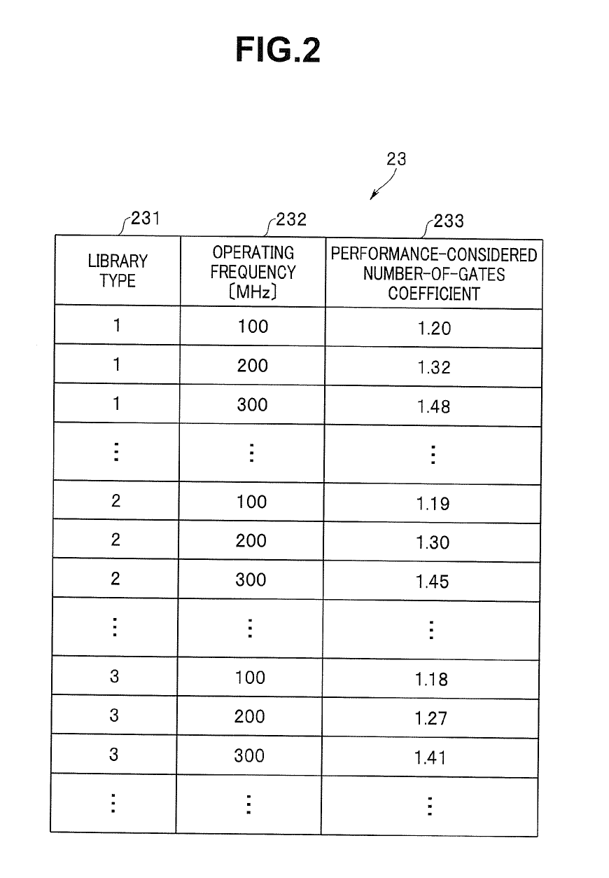

In the set value storing section 21, a chip size estimating coefficient table 23, shown in FIG. 2 for example, in which set values for use in chip size estimation is inputted is stored. FIG. 2 is a diagram showing one example of the chip size estimating coefficient table 23.

As shown in FIG. 2, the chip size estimating coefficient table 23 is configured by columns of three items of a library type 231 for discriminating a cell library, an operating frequency 232 and a performance-considered number-of-gates coefficient 233.

In the library type 231, unique numbers, character strings or the like for discriminating cell libraries are set in such a manner as to set “1” for a cell library of a cell height of seven grids, set “2” for a cell library of nine grids, and set “3” for a cell library of 11 grids, for example.

In the operating frequency 232, typical numeric values (for example, 100 [MHz], 200 [MHz], 300 [MHz], and the like) of the operating frequency in a range in which estimation is likely to be performed are set.

The performance-considered number-of-gates coefficient 233 is a value obtained by dividing the number of gates (number of gates placed in an actual design stage) expressing the circuit size of the random logic section mounted on a chip by the minimum number of functional gates.

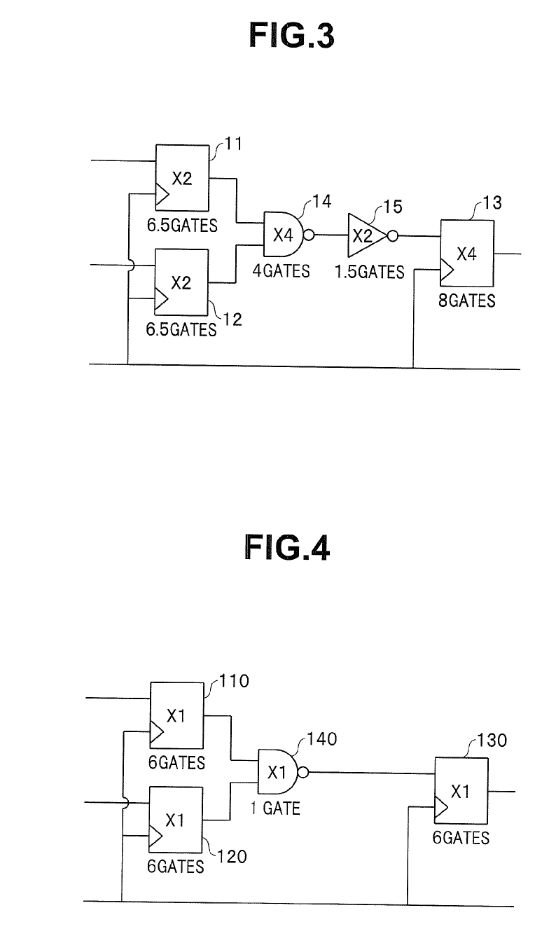

Here, the performance-considered number-of-gates coefficient 233 and a minimum number of functional gates will be described with use of FIGS. 3 and 4. FIG. 3 is a diagram explaining one example of a circuit that is designed in consideration of operation timing, and FIG. 4 is a diagram explaining a circuit that is configured with an objective of only realizing a function similar to that of the circuit of FIG. 3 without consideration of the operation timing.

The circuit shown in FIG. 3 is configured by cells of three flip flops 11, 12 and 13, a NAND 14 and a buffer 15. In each of the cells 11 to 15, a drive capacity of each of the cells is described inside each of symbols as a multiplying factor with respect to a drive capacity of a cell with a minimum drive capacity. More specifically, each of the flip flops 11 and 12 has a drive capacity twice as large as that of the flip flop with the minimum drive capacity, and the flip flop 13 has the drive capacity four times as large as that of the flip flop with the minimum drive capacity. Further, the NAND 14 has the drive capacity four times as large as that of a NAND with a minimum drive capacity, and the buffer 15 has the drive capacity twice as large as that of a buffer with a minimum drive capacity.

Further, in FIG. 3, the number of functional gates that configure each of the cells 11 to 15 is described at a lower part of each of the symbols. The functional gate defines four transistors as one gate. For example, a two-input NAND cell with a minimum drive capacity is configured by four transistors, and therefore, the number of functional gates of the NAND cell is one.

As the definition of gates, an area gate is cited besides a functional gate. An area gate defines an area of the two-input NAND cell with the minimum drive capacity as one gate. Accordingly, the number of functional gates and the number of area gates of the two-input NAND cell with the minimum drive capacity are both one.

In the circuit shown in FIG. 3, the number of functional gates of each of the flip flops 11 and 12 is 6.5, and the number of functional gates of the flip flop 13 is eight. Further, the number of functional gates of the NAND 14 is four, and the number of functional gates of the buffer is 1.5. Accordingly, the number of functional gates of the entire circuit is 26.5. Even with the same functions and operating frequencies, the drive capacities of the respective cells, the number of interposed buffers and the like change if the cell library for use differs, and therefore, the number of functional gates of the entire circuit can be larger or smaller than 26.5.

Meanwhile, the circuit shown in FIG. 4 is designed without consideration of operation timing, and therefore, a buffer is not interposed therein. Accordingly, the circuit is configured only by three flip flops 110, 120 and 130 each with a minimum drive capacity, and a NAND 140. As for the number of functional gates of each of the cells, the number of functional gates of each of the flip flops 110, 120 and 130 is six, and the number of functional gates of the NAND 140 is one. Accordingly, the number of the functional gates of the entire circuit is 19.

The total number of functional gates of the circuit with only realization of the function taken into consideration without consideration of operation timing as shown in FIG. 4 is defined as the minimum number of functional gates. The minimum number of functional gates is considered to have less dependence on a cell library. Further, the value that is obtained by dividing the total number of functional gates of the circuit that is designed in consideration of operation timing in order to achieve an operation speed of a predetermined operating frequency as shown in FIG. 3 by the minimum number of functional gates is defined as a performance-considered number-of-gates coefficient. More specifically, the performance-considered number-of-gates coefficient in the circuit shown in FIG. 3 is 26.5/19=1.39.

As described above, the number of functional gates of the circuit often takes a different value if the cell library differs even if the operating frequency is the same. Further, if the operating frequency differs, even if the same library is used, the number of functional gates is highly likely to be a different value as a matter of course, because cells having different drive capacities are used, and a buffer is interposed/deleted. Accordingly, the performance-considered number-of-gates coefficient takes a different value in accordance with the operating frequency and a cell library, and becomes the value reflecting increase/decrease of the circuit size due to the characteristics of the cell library and the operating frequency.

The values of the performance-considered number-of-gates coefficient 233 in the chip size estimating coefficient table 23 shown in FIG. 2 are only examples. The performance-considered number-of-gates coefficient 233 is properly set to an optimal value in accordance with the characteristics of a cell library, a circuit and the like, and estimation is performed. For calculation of the performance-considered number-of-gates coefficient, a method is used, which performs logic synthesis or the like for a plurality of circuits by changing an operating frequency in each of the circuits and statistically calculates the performance-considered number-of-gates coefficient based on the number of gates that is obtained as the result thereof, or statistically estimates the performance-considered number-of-gates coefficient from actual circuit sizes in the circuits for which estimation is performed in the past.

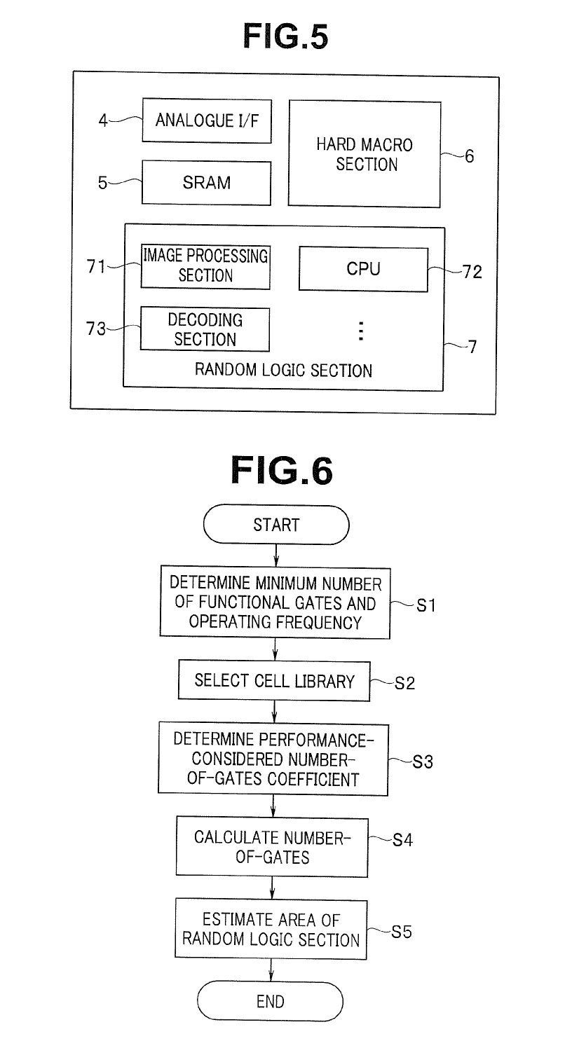

Next, a chip size estimating method in the present embodiment will be described with use of a specific example shown in FIG. 5 and a flowchart shown in FIG. 6. FIG. 5 is a diagram explaining one example of layout of a chip that is an object of estimation of a chip size, and FIG. 6 is a flowchart explaining a procedure of estimating an area of the random logic section 7.

The chip shown in FIG. 5 is, for example, a chip for a cellular phone, and has an analogue I/F 4, an SRAM 5, a hard macro section 6, and a random logic section 7. The random logic section 7 has cells of an image processing section 71, a CPU 72, a decoding section 73 and the like.

Hereinafter, the procedure of estimating the area of the random logic section 7 in order to estimate the size of the chip of FIG. 5 will be described in accordance with FIG. 6.

First, in step S1, the minimum number of functional gates of the random logic section 7 that is an estimation object, and the operating frequency that is an estimation condition are determined, and inputted from the input section 1. Next, the flow proceeds to step S2, where the cell library of an estimation object is selected, and is inputted from the input section 1. A plurality of cell libraries may be selected, or only one cell library may be selected.

Subsequently, the flow proceeds to step S3, the performance-considered number-of-gates coefficient is determined based on the minimum number of functional gates and the operating frequency that are inputted in step S1, and the cell library selected in step S2. More specifically, with reference to the chip size estimating coefficient table 23 that is stored in the set value storing section 21, and with the library type 231 used as a key, record corresponding to the cell library selected in step S2 is extracted. Further, with the operating frequency 232 as a key, a record corresponding to the operating frequency that is inputted in step S1 is extracted. A value that is set in the item of the performance-considered number-of-gates coefficient 233, of the extracted record is determined as the value of the performance-considered number-of-gates coefficient that is used in estimation.

Next, in step S4, the minimum number of functional gates that is inputted in step S1 is multiplied by the performance-considered number-of-gates coefficient determined in step S3, and the number of gates of the random logic section 7 that is the estimation object is calculated. In the end, the flow proceeds to step S5, and the area of the random logic section 7 is estimated based on the number of gates that is calculated in step S4.

As the estimating method of the area, various methods can be cited and used. Here, one example is cited. First, an increment of cells that are predicted to be added to the number of gates calculated in step S4 due to DFT (Design for Test) design in the logic design and thereafter, clock tree generation, layout design with consideration of timing and the like. The number of gates is multiplied by an area coefficient (area per one functional gate) which is dependent on the cell library, and the area is calculated. The increment of cells in logic design and thereafter, and the area coefficient can be included in the performance-considered number-of-gates coefficient in advance, and in such a case, the aforementioned multiplying processing is not necessary.

Subsequently, the area of the cells that is calculated is divided by a cell placement density (Utilization), and estimation of the area of the random logic section 7 is completed. As for the way of determining the value of the cell placement density, various methods are conventionally available such as a method based on the past empirical values, and an optimal method can be used. Further, the value of the cell placement density often changes dependently on the cell library, the number of gates and the like, and therefore, a table like the chip size estimating coefficient table 23 or a formula for calculating the cell placement density with the number of gates as a variable may be prepared for each cell library, and stored in the set value storing section 21.

In step S1, when the minimum number of functional gates is unknown, and, for example, the number of gates that is obtained as a result of estimation in a predetermined operating frequency in a specific cell library is known, for example, if the estimation result is obtained with respect to the circuit with the same function/the same operating frequency using a different cell library, but the minimum number of functional gates is unknown, the minimum number of functional gates is calculated and set as an input value as follows (the case of comparing the circuit sizes among a plurality of cell libraries or the like is likely to correspond to the above).

First, the chip size estimating coefficient table 23 is referred to, and a record corresponding to the cell library for which estimation is carried out is extracted with the library type 231 as a key. Further, the record corresponding to the operating frequency for which estimation is carried out is extracted with the operating frequency 232 as a key. The known number of gates is divided by the value that is set in the item of the performance-considered number-of-gates coefficient 233 of the extracted record, and the minimum number of functional gates is calculated.

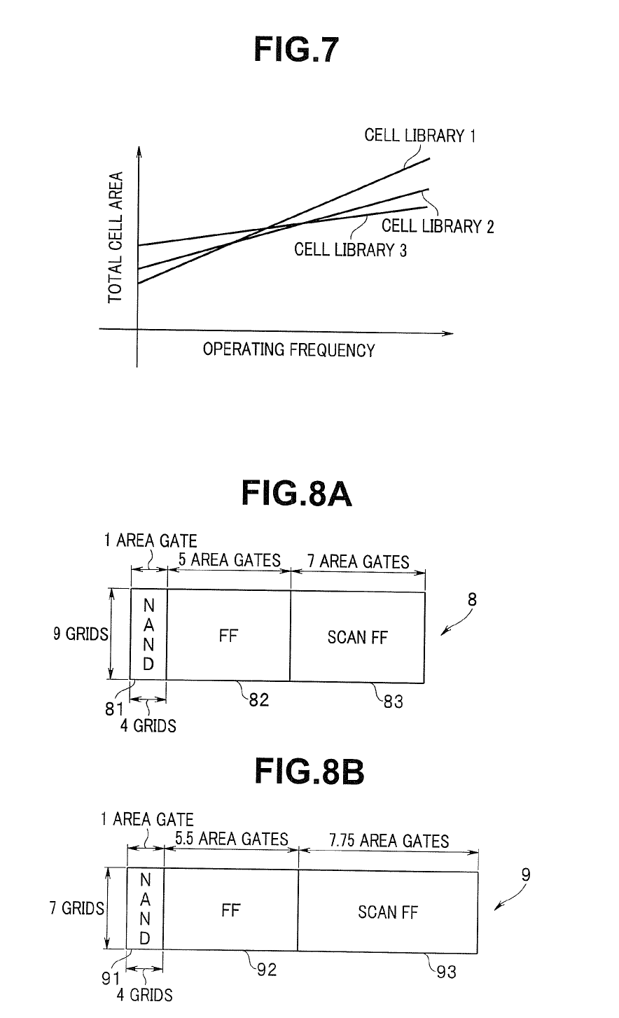

The relation of the total cell area of the random logic section 7 that is thus calculated and the operating frequency is shown in FIG. 7. FIG. 7 is a graph showing the relation of the total cell area that is calculated according to the present embodiment with respect to the random logic section 7 of FIG. 6 and the operating frequency. In FIG. 7, an estimation result in the cell library of seven grids is shown as a cell library 1, an estimation result in the cell library of nine grids is shown as a cell library 2, and an estimation result of the cell library of eleven grids is shown as a cell library 3.

As shown in FIG. 7, when the operating frequency becomes higher, the total cell areas become larger in all the cell libraries. However, the ratios of increases of the total cell areas to the operating frequency (corresponding to the gradients of the straight lines) differ depending on the cell libraries, and the cell library with a lower cell height has the ratio of the increase larger than the cell library with a higher cell height.

In general, as the cell height becomes higher, the performance of the cell becomes higher and the operation speed becomes higher even with the same number of functional gates in many cases. As the operating frequency becomes higher, it becomes necessary to use a cell with a large drive capacity and interpose buffers in order to realize operation timing, but the library with a high cell height originally uses high-performance cells, and therefore, has less necessity as compared with the library with a low cell height. Accordingly, the relation as shown in FIG. 7 (the ratios of increases of the total cell areas to the operating frequency are in the sequence of the cell library 3< the cell library 2< the cell library 1) can be said as reflecting the realities in circuit design.

In the region with the small operating frequency, there is less necessity for using a large cell with a high drive capacity and interposing a buffer, and therefore, the cell library of grids with a lower height with a smaller area of a transistor for use in the cell tends to have a smaller total area of the cells. Accordingly, when the total cell area in the case of using a cell library of seven grids is set as S₇, the total cell area in the case of using a cell library of nine grids is set as S₉, and the total cell area in the case of using a cell library of eleven grids is set as S₁₁, S₇<S₉<S₁₁ is satisfied as shown in FIG. 7.

When the operating frequency becomes high, the necessity for interposing a cell with a large drive capacity and a number of buffers occurs in the cell library of seven grids, and therefore, the total cell area of the cell library of seven grids becomes larger than the total area of the cell library of nine grids (S₉<S₇<S₁₁). When the operating frequency becomes higher, the total cell area of the cell library of seven grids becomes larger than the total area of the cell library of 11 grids (S₉<S₁₁<S₇).

Further, when the operating frequency becomes higher, the number of cells with a large drive capacity for use, and the number of buffers interposed therein also increase in the cell library of nine grids, and the total cell area becomes larger than the total cell area of the cell library of eleven grids (S₁₁<S₉<S₇). Accordingly, in the region with the high operating frequency, the total area of the cells in the case of using the cell library of eleven grids that has the highest grid height is estimated as the smallest.

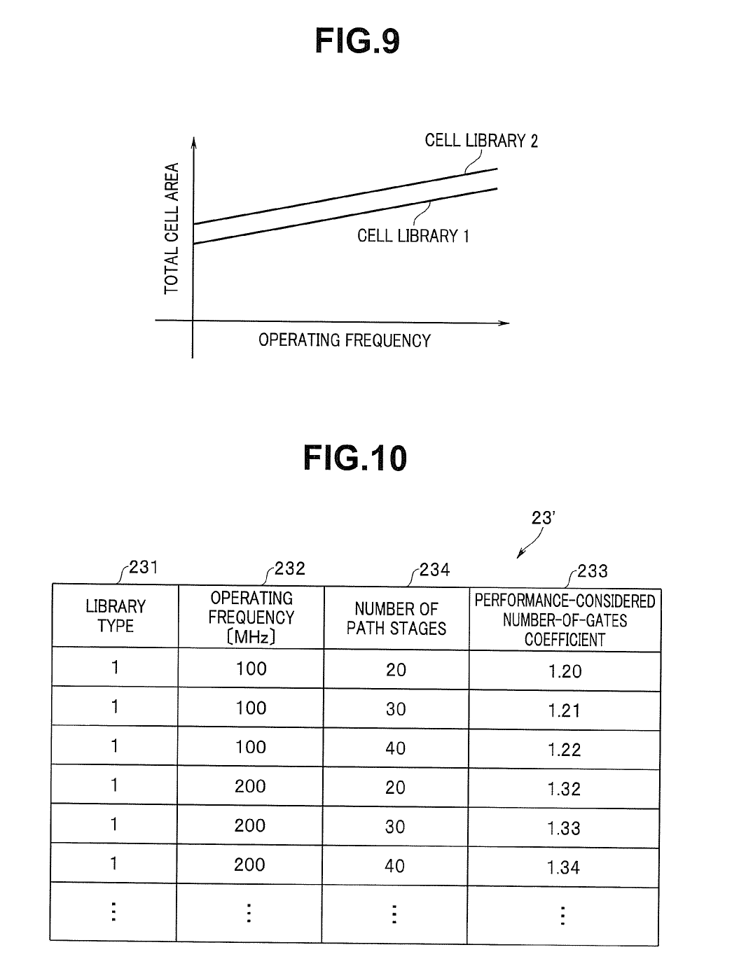

Here, the estimation result according to the method of the present embodiment is compared with the result of estimation that is performed according to the conventional method. Hereinafter, estimation of a total cell area with the conventional method will be described with use of FIGS. 8A and 8B and FIG. 9. FIGS. 8A and 8B are diagrams explaining layout of cells of estimation objects. FIG. 8A shows the layout of the cell using a cell library of nine grids, and FIG. 8B shows the layout of the cell using a cell library of seven grids and having the same function as that of FIG. 8A. Further, FIG. 9 is a graph showing a relation between the total cell area calculated according to the conventional method and the operating frequency.

A cell 8 shown in FIG. 8A that uses the cell library of nine grids is configured by a two-input NAND 81, a flip flop 82 and a scan FF 83 that are arranged in parallel. All of the two-input NAND 81, the flip flop 82 and the scan FF 83 are configured by cells with minimum drive capacities. That is to say, the minimum number of functional gates and the number of area gates of the NAND 81 are one. Further, the number of functional gates of the flip flop 82 is six, and the number of area gates of the flip flop 82 is five. Further, the number of functional gates of the scan FF 83 is eight, and the number of area gates of the scan FF 83 is seven.

Meanwhile, a cell 9 shown in FIG. 8B using a cell library of seven grids is configured by a two-input NAND 91, a flip flop 92 and a scan FF 93 that are arranged in parallel. Respective cells have the same functions as those of the cells shown in FIG. 8A, and have the equal numbers of transistors. Accordingly, the number of functional gates of the NAND 91 is one, the number of functional gates of the flip flop 92 is six, and the number of functional gates of the scan FF is eight. Accordingly, in each of the cell library of nine grids and the cell library of seven grids, the total number of functional gates is 15.

In contrast with this, when an area gate is considered, in a larger cell with a complicated function, a wiring structure among transistors becomes more complicated in general, and therefore, a cell with a lower height needs a larger width as compared with a cell with a higher height. Accordingly, the width of the NAND 91 is equal to the width of the NAND 81, and the number of area gates of the NAND 91 is one, but the widths of the other cells are large, and therefore, the numbers of area gates are large proportionally thereto. More specifically, the number of area gates of the flip flop 92 is 5.5, the number of area gates of the scan FF is 7.75, and the number of area gates of the entire cell 9 is 14.25 in total.

The value of the number of the area gates is the value larger than the total number (=13) of the area gates of the cell 8 using the cell library of nine grids, but the area per one area gate is smaller in the cell library of seven grids than the cell library of nine grids.

When the actual area is calculated, the cell 8 has 9×13=117 square grids, whereas the cell 9 has 7×14.25=99.75, and the actual area is estimated as smaller when the cell library of seven grids with a lower height is used.

Based on the above description, the case of estimating the total areas of the random logics in the cell library of nine grids and the cell library of seven grids by changing the operating frequency, and comparing the results is considered. As the circuit size set as input at the time of estimation, there are cases of using the number of gates as the result of performing logic synthesis in any of the cell libraries or still another cell library, estimating the circuit size from the number of gates of the analogous integrated circuit of the past, and the like. In any case, as the operating frequency becomes higher, the number of gates tends to be larger. This is because for the purpose of achieving the operation speed, cells with a large drive capacity are used, and insertion of buffer cells is needed.

The number of gates (functional gates or the area gates) which is obtained as described above is inputted in both the cell libraries, and at this time, the same number of gates is inputted in each of the cell libraries. The result of executing estimation by inputting the number of gates is shown in FIG. 9. In FIG. 9, the estimation result in the cell library of seven grids is shown as a cell library 1, and the estimation result of the cell library of nine grids is shown as a cell library 2.

As shown in FIG. 9, with respect to each of the cell libraries, when the operating frequency becomes higher, the total cell area becomes larger with increase in the number of gates that is inputted. Further, the ratios of increases of the total cell areas to the operating frequency (corresponding to the gradients of the straight lines) are substantially the same ratios irrespective of the cell libraries. Accordingly, in any frequency area, the total area of the cells is evaluated to be smaller in the case of use of the cell library of seven grids than in the case of use of the cell library of nine grids.

However, as the cell height becomes higher, the performance of the cell becomes better and the operation speed becomes higher even with the same number of functional gates in many cases. As the operating frequency becomes higher, it becomes necessary to use a cell with a large drive capacity and interpose buffers in order to realize operation timing, but the library with a higher cell height originally uses the cells with higher performance, and therefore, has less necessity for using the cell with high drive capacity and interposing buffers as compared with the library with a low cell height. Therefore, as the operating frequency becomes higher, the circuit size tends to be smaller in the cell library of nine grids than in the cell library of seven grids. More specifically, as the operating frequency becomes higher, the number of gates that is an input value becomes the value more deviating from the number of gates that are actually placed in the circuit design, and the estimation accuracy becomes worse.

In comparison with this, in the present embodiment, as the circuit size for use in estimation of the total area, the suitable number of gates in consideration of the characteristics of the cell library to be an estimation object and the operating frequency is used, and therefore, the estimation accuracy can be enhanced. Further, the circuit size (= the number of gates actually placed in the design stage) for use in estimation of the total area is expressed by the product of the minimum number of functional gates which is less dependent on the cell library and the performance-considered number-of-gates coefficient which has a value differing dependently on the characteristics of the cell library and the operating frequency, the performance-considered number-of-gates coefficient is set in the apparatus in advance, and the minimum number of functional gates is used as the input information for estimation, whereby when estimation of a different cell library is performed, the same value can be inputted without necessity for changing the value of input at each time, and therefore, estimation can be easily performed.

In the aforementioned embodiment, the performance-considered number-of-gates coefficient of a typical operating frequency is calculated in advance, and is stored in the apparatus in the table format as shown in FIG. 2, but only if the value of the performance-considered number-of-gates coefficient can be derived from the operating frequency for each cell library, the relational expression of the operating frequency and the performance considered number-of-gates coefficient may be obtained in advance for each cell library and stored in the apparatus, for example, and the relational expression may be used instead of the table.

Further, the chip size estimating coefficient table 23 shown in FIG. 2 may be divided into each cell library, and held as a plurality of tables.

Furthermore, the performance-considered number-of-gates coefficient also depends on the number of logic stages of a path of the flip flops in the circuit of an estimation object, for example, besides the operating frequency. Accordingly, an item called a number of path stages 234 representing the number of logic stages of the path of the flip flops is added to the chip size estimating coefficient table 23 shown in FIG. 2, and a chip size estimating coefficient table 23′ as shown in FIG. 10 may be created and used in estimation. FIG. 10 is a diagram explaining one example of the chip size estimating coefficient table 23′.

### Modified Example

Next, a modified example of the aforementioned embodiment will be described. In the aforementioned embodiment, all the cell libraries that are estimation objects are configured by basic gates, but in the modified example, estimation is performed with a cell library including a composite gate configured by the combination of a plurality of basic gates set as an object.

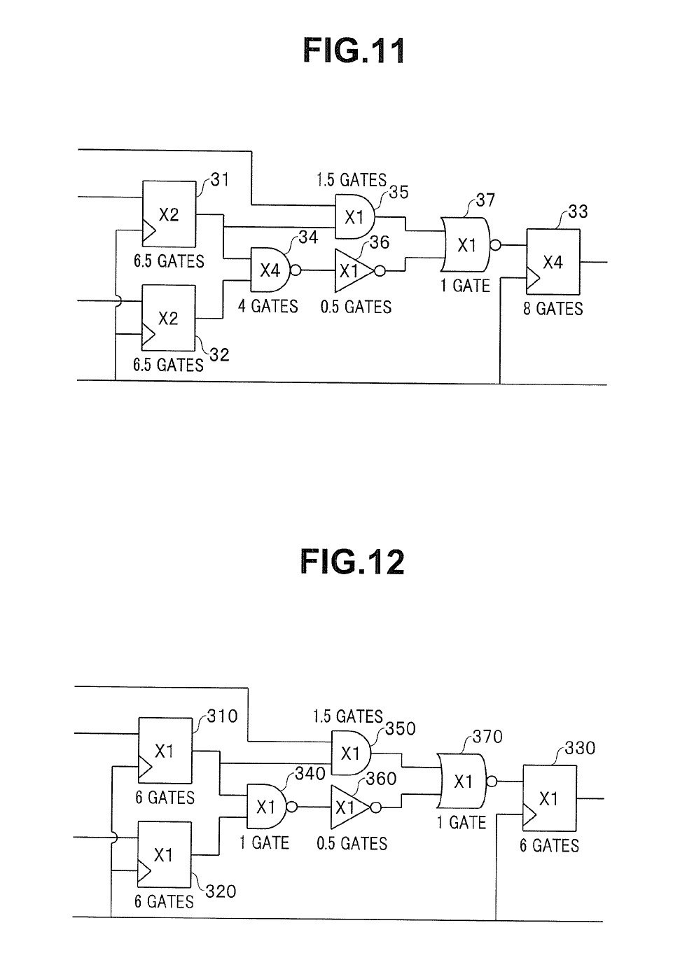

Hereinafter, estimation of a cell library including a composite gate will be described by illustration of a specific circuit, with use of FIGS. 11 to 13. The description will be made in the manner of comparison of a circuit configured with use of the cell library including a composite gate, and a circuit configured by using the cell library configured with use of only basic gates.

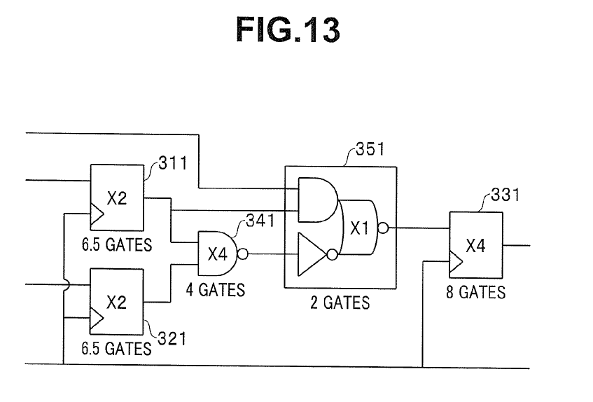

FIG. 11 is a diagram explaining one example of a circuit that is designed in consideration of operation timing by using a cell library configured only by basic cells, and FIG. 12 is a diagram explaining a circuit that is configured with an objective of only realizing the function similar to that of the circuit of FIG. 11 without consideration of the operation timing. FIG. 13 is a diagram explaining one example of a circuit that has the function similar to that of the circuit of FIG. 11, and is designed in consideration of the operation timing with use of a different cell library including a composite cell.

The circuit shown in FIG. 11 is configured only by basic cells, and more specifically, is configured by cells of three flip flops 31, 32 and 33, a NAND 34, an AND 35, a NOT 36, and a NOR 37. Each of the cells has a drive capacity in consideration of operation timing. The flip flops 31 and 32 have the drive capacities twice as large as that of a flip flop with a minimum drive capacity, and the flip flop 33 has the drive capacity four times as large as that of the flip flop with the minimum drive capacity. Further, the NAND 34 has the drive capacity four times as large as that of a NAND with a minimum drive capacity. Further, the AND 35, the NOT 36 and the NOR 37 have the minimum drive capacities.

Further, in the circuit shown in FIG. 11, the number of functional gates of each of the flip flops 31 and 32 is 6.5, and the number of functional gates of the flip flop 33 is eight. Further, the number of functional gates of the NAND 34 is four, and the number of functional gates of the AND 35 is 1.5. Further, the number of functional gates of the NOT 36 is 0.5, and the number of functional gates of the NOR 37 is one. Accordingly, the number of functional gates of the entire circuit is 28.

Meanwhile, the circuit shown in FIG. 12 is designed without consideration of operation timing, and therefore, is configured only by cells each with a minimum drive capacity. More specifically, the circuit is configured by cells of three flip flops 310, 320 and 330 each with a minimum drive capacity, and a NAND 340, an AND 350, a NOT 360 and a NOR 370 each with a minimum drive capacity. As for the number of functional gates of each cell, the numbers of functional gates of the flip flops 310, 320 and 330 are six, and the numbers of functional gates of the NAND 340 and the NOR 37 are one. Further, the number of functional gates of the AND 350 is 1.5, and the number of functional gates of the NOT 360 is 0.5. Accordingly, the number of functional gates of the entire circuit is 22.

Furthermore, the circuit shown in FIG. 13 has the same function as that of the circuit shown in FIG. 11, and is a similar circuit in consideration of the operation timing, but uses a different cell library including a composite gate. More specifically, the circuit is configured by three flip flops 311, 321 and 331, a NAND 341, and a composite gate cell 351 with an AND, a NOT and a NOR combined into one cell.

Each of the cells has a drive capacity in consideration of operation timing. The flip flops 311 and 321 each have a drive capacity twice as large as that of a flip flop with a minimum drive capacity, and the flip flop 331 has a drive capacity four times as large as that of the flip flop with the minimum drive capacity. Further, the NAND 341 has a drive capacity four times as large as a NAND with a minimum drive capacity. Further, the composite gate cell 351 has a minimum drive capacity.

Further, in the circuit shown in FIG. 13, the number of functional gates of the flip flops 311 and 321 is 6.5, and the number of functional gates of the flip flop 331 is eight. Further, the number of functional gates of the NAND 341 is four, and the number of functional gates of the composite gate cell 351 is two. Accordingly, the number of functional gates of the entire circuit is 27.

The circuit shown in FIG. 11 and the circuit shown in FIG. 13 are the circuits with an objective of realizing the same function/operation speed, and use cell libraries with equivalent performances (uses the cell libraries of the grids with the same heights). However, the number of functional gates of the entire circuit shown in FIG. 11 is 28, whereas the number of functional gates of the entire circuit shown in FIG. 13 is 27, and is smaller by one functional gate than the circuit of FIG. 11.

The difference in the number of gates is attributed to the fact that the cell library that is used in FIG. 11 is configured only by basic cells, whereas in the cell library that is used in FIG. 13, the composite gate cell is also prepared. That is, the number of gates of the actual circuit changes depending on the presence or absence of the lineup of a composite gate cell, the kind and the number of composite gate cells that are prepared.

Thus, the number of functional gates of the entire circuit that is configured only by the basic cells with an objective of only realizing the function similar to those of the circuits of FIGS. 11 and 13 without consideration of operating timing as shown in FIG. 12, is set as the minimum number of functional gates. More specifically, the minimum number of functional gates in this case is 22. When the numbers of functional gates of the entire circuits of FIGS. 11 and 13 are expressed as the products of the minimum numbers of functional gates and the performance-considered number-of-gates coefficients, the performance-considered number-of-gates coefficient of the circuit of FIG. 11 is 28/22=1.27, and the performance-considered number-of-gates coefficient of the circuit of FIG. 13 is 27/22=1.23.

As described above, the performance-considered number-of-gates coefficient is calculated for each of cell libraries with different lineups of composite gate cells, and the values of the performance-considered number-of-gates coefficients to the operating frequencies are set in advance in a table format like the chip size estimating coefficient table 23 shown in FIG. 2, for example. Thus, when estimation of the cell libraries with different lineups of composite gate cells is performed, the value of input does not have to be changed at each time, and the minimum number of functional gates can be inputted as a common input value, the value of input does not have to be changed for each cell library, whereby estimation can be performed easily.

The actual number of gates is calculated by multiplication of the inputted minimum number of functional gates and the performance-considered number-of-gates coefficient corresponding to the estimation condition, and is used for estimation of the total area. Therefore, the suitable number of gates in consideration of the characteristics of the cell library to be an estimation object and the operating frequency can be used, and the estimation accuracy can be enhanced.

While a certain embodiment has been described, the embodiment has been presented by way of example only, and is not intended to limit the scope of the inventions. Indeed, the novel methods and devices described herein may be embodied in a variety of other forms; furthermore, various omissions, substitutions and changes in the form of the methods and devices described herein may be made without departing from the spirit of the inventions. The accompanying claims and their equivalents are intended to cover such forms or modifications as would fall within the scope and spirit of the inventions.

What is claimed is:

1. A chip size estimating apparatus for a semiconductor integrated circuit, comprising:
an input module configured to input a minimum number of functional gates that is a minimum number of gates necessary for realization of a function of a circuit;
a set value holding module in which a performance-considered number-of-gates coefficient that is a ratio of a number of gates to be necessary for achievement of a predetermined operation speed to the minimum number of functional gates is set in advance for each cell library; and
a calculating module configured to estimate a total area of the circuit by using a number of gates that is calculated from the minimum number of functional gates and the performance-considered number-of-gates coefficient.

2. The chip size estimating apparatus for a semiconductor integrated circuit of claim 1,
wherein the performance-considered number-of-gates coefficient is associated with an operating frequency and stored in the set value holding module.

3. The chip size estimating apparatus for a semiconductor integrated circuit of claim 1,
wherein the performance-considered number-of-gates coefficient is associated with a number of logical stages of a path of the circuit and stored in the set value holding module.

4. The chip size estimating apparatus for a semiconductor integrated circuit of claim 1,
wherein the cell library includes a cell library configured by cells that include a composite gate cell.

5. The chip size estimating apparatus for a semiconductor integrated circuit of claim 2,
wherein the performance-considered number-of-gates coefficient is associated with a number of logical stages of a path of the circuit and stored in the set value holding module.

6. The chip size estimating apparatus for a semiconductor integrated circuit of claim 2,
wherein the cell library includes a cell library configured by cells that include a composite gate cell.

7. The chip size estimating apparatus for a semiconductor integrated circuit of claim 5,
wherein the cell library includes a cell library configured by cells that include a composite gate cell.

8. A chip size estimating method for a semiconductor integrated circuit, comprising:
inputting a minimum number of functional gates that is a minimum number of gates necessary for realization of a function of a circuit and an operating frequency;
selecting a cell library of an estimation object;
determining a performance-considered number-of-gates coefficient of a specific value for use in estimation from the performance-considered number-of-gates coefficient that is set in advance for each cell library, and is a ratio of a number of gates to be necessary for achievement of a predetermined operation speed to the minimum number of functional gates, based on from the minimum number of functional gates and the operating frequency that are inputted and the selected cell library;
calculating a number of gates for use in estimation from the minimum number of functional gates and the determined performance-considered number-of-gates coefficient; and
estimating a total area of the circuit by using the calculated number of gates.

9. The chip size estimating method for a semiconductor integrated circuit of claim 8,
wherein the performance-considered number-of-gates coefficient is associated with an operating frequency and stored.

10. The chip size estimating method for a semiconductor integrated circuit of claim 8,
wherein the performance-considered number-of-gates coefficient is associated with a number of logical stages of a path of the circuit and held.

11. The chip size estimating method for a semiconductor integrated circuit of claim 8,
wherein the cell library includes a cell library configured by cells that include a composite gate cell.

12. The chip size estimating method for a semiconductor integrated circuit of claim 9,
wherein the performance-considered number-of-gates coefficient is associated with a number of logical stages of a path of the circuit and held.

13. The chip size estimating method for a semiconductor integrated circuit of claim 9,
wherein the cell library includes a cell library configured by cells that include a composite gate cell.

14. The chip size estimating method for a semiconductor integrated circuit of claim 12,
wherein the cell library includes a cell library configured by cells that include a composite gate cell.

15. A chip size estimating apparatus for a semiconductor integrated circuit, comprising:
an input module configured to input a minimum number of functional gates that is a minimum number of gates necessary for realization of a function of a circuit, and determine one specific cell library or a plurality of specific cell libraries of an estimation object;
a set value holding module in which a performance-considered number-of-gates coefficient that is a ratio of a number of gates to be necessary for achievement of a predetermined operation speed to the minimum number of functional gates is set in advance for each of the cell library or the cell libraries; and
a calculating module configured to estimate a total area of the circuit by using an estimated number of gates that is calculated by multiplication of the minimum number of functional gates and the performance-considered number-of-gates coefficient.

16. The chip size estimating apparatus for a semiconductor integrated circuit of claim 15,
wherein the performance-considered number-of-gates coefficient is associated with an operating frequency and stored in the set value holding module.

17. The chip size estimating apparatus for a semiconductor integrated circuit of claim 15,
wherein the performance-considered number-of-gates coefficient is associated with a number of logical stages of a path of the circuit and stored in the set value holding module.

18. The chip size estimating apparatus for a semiconductor integrated circuit of claim 15,
wherein the cell library or the cell libraries includes or include a cell library configured by cells that include a composite gate cell.

19. The chip size estimating apparatus for a semiconductor integrated circuit of claim 16,
wherein in the input module, the specific operating frequency of the estimation object is further inputted, and in the calculating module, the estimated number of gates is calculated by using the performance-considered number-of gates coefficient corresponding to the specific operating frequency and the specific cell library or cell libraries.

20. The chip size estimating apparatus for a semiconductor integrated circuit of claim 17,
wherein in the input module, the number of logical stages of the path of the circuit of the estimation object is further inputted, and in the calculating module, the estimated number of gates is calculated with use of the performance-considered number-of-gates coefficient corresponding to the number of logical stages of the path of the circuit and the specific cell library or cell libraries.
